(19) United States
(12) Patent Application Publication
(10) Pub. No.: US 2025/0157101 A1
(43) Pub. Date: May 15, 2025

(54) RECORDING MEDIUM, LEARNING SUPPORT DEVICE, AND LEARNING SUPPORT METHOD

(71) Applicant: JUSTSYSTEMS CORPORATION, Tokushima-shi (JP)

(72) Inventors: Mai KAWAMURA, Tokyo (JP); Ayano KITAMOTO, Tokyo (JP); Yuki KAJIWARA, Tokyo (JP)

(73) Assignee: JUSTSYSTEMS CORPORATION, Tokushima-shi (JP)

(21) Appl. No.: 18/945,818

(22) Filed: Nov. 13, 2024

(30) Foreign Application Priority Data
Nov. 15, 2023 (JP) 2023-194771

(51) Int. Cl. G06T 11/20; G06T 5/50

(52) U.S. Cl. CPC G06T 11/203; G06T 5/50; G06T 2207/20221

(57) ABSTRACT

A computer-readable recording medium stores therein a learning support program that causes a computer to execute a process including: receiving input of a character that a user is requested to write, the character being handwritten and input by the user; recognizing the input character or strokes of the input character; judging the recognized character or a stroke order of the strokes of the recognized character; and outputting information concerning a result of the judging.

### CROSS REFERENCE TO RELATED APPLICATIONS

This application is based upon and claims the benefit of priority of the prior Japanese Patent Application NO. 2023-194771, filed on Nov. 15, 2023, the entire contents of which are incorporated herein by reference.

### BACKGROUND OF THE INVENTION

### 1. Field of the Invention

Embodiments of the invention relate to a recording medium, a learning support device, and a learning support method.

### 2. Description of the Related Art

There is a technology in which answers to questions posed to a user via a terminal device are received by handwritten input performed by the user, the answers received through the handwritten input are subjected to pattern recognition and results of determining whether the answers are correct or incorrect based on the pattern-recognized answers and correct answers (samples) stored in advance are displayed (for example, refer to Japanese Laid-Open Patent Publication NO. 2008-241736).

Further, there is a technique for determining whether a writing starting point and a writing ending point are within a specified range by comparing handwritten input characters with character information (samples) that serves as criteria for determining whether the handwritten input characters are correct (for example, refer to Japanese Laid-Open Patent Publication NO. 2012-225980).

### SUMMARY OF THE INVENTION

According to an embodiment of the present invention, a computer-readable recording medium stores therein a learning support program that causes a computer to execute a process including: receiving input of a character that a user is requested to write, the character being handwritten and input by the user; recognizing the input character or strokes of the input character; judging the recognized character or a stroke order of the strokes of the recognized character; and outputting information concerning a result of the judging.

Objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an explanatory diagram depicting a system configuration of a correspondence education system.

FIG. 2A is an explanatory diagram depicting an example of a hardware configuration of a computer device implementing a server.

FIG. 2B is an explanatory diagram depicting an example of a hardware configuration of a computer device implementing an operation terminal.

FIG. 3 is a block diagram depicting a functional configuration of the operation terminal.

FIG. 4 is an explanatory diagram depicting an example of a stroke order display screen displayed on a display by the operation terminal.

FIG. 5A is an explanatory diagram depicting an example of a stroke order display screen displayed on the display by the operation terminal.

FIG. 5B is an explanatory diagram depicting an example of a stroke order display screen displayed on the display by the operation terminal.

FIG. 6 is a diagram depicting an example of a screen display of a learning material application for learning a stroke order of characters.

FIG. 7 is a diagram depicting an example of a screen display of the learning material application for learning the stroke order of characters.

FIG. 8 is a diagram depicting an example of a screen display of the learning material application for learning the stroke order of characters.

FIG. 9 is a flowchart depicting an example of a character learning process.

FIG. 10 is a flowchart depicting another example of a processing procedure for character learning.

### DETAILED DESCRIPTION OF THE INVENTION

First, problems associated with the conventional techniques are discussed. Each of the conventional techniques above determines, based on a degree of similarity to a sample, whether a handwritten input character is correct or incorrect and has a problem in that the user cannot be made aware of the specific way of writing characters in the correct stroke order. While a handwritten character that is not written in the correct stroke order can be made to resemble a sample, it cannot be said that learning to write the character has been achieved and there is a problem in that the intended effect of learning to handwrite characters cannot be achieved. Constant monitoring of the learning of the user and instructing the user to write characters in the correct stroke order such as by a parent of the user is not realistic.

The first time the user, for example, a child, writes characters such as hiragana, it is necessary to teach the user that each of strokes must be written in one stroke.

Embodiments of a recording medium, a learning support device, and a learning support method according to the present invention are described in detail with reference to the accompanying drawings. The present invention encourages the user to write characters in the proper stroke order. In some countries, the stroke order of characters is not specified. In the present invention, for various characters to be learned, a predetermined stroke order for a character is presented to the user as a sample, and a judgment is made as to whether the user's actual stroke order is the same as the sample and the user is notified of the result, thereby supporting the user to write the entire character.

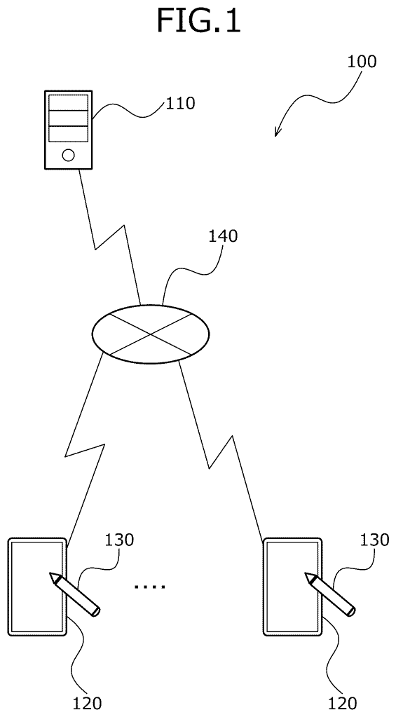

A system configuration of a correspondence education system including learning support devices according to an embodiment of the present invention is described. FIG. 1 is an explanatory diagram depicting the system configuration of the correspondence education system.

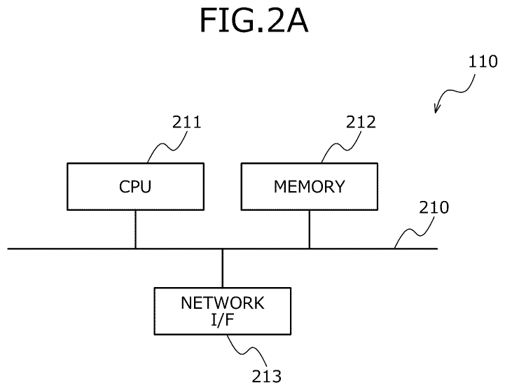

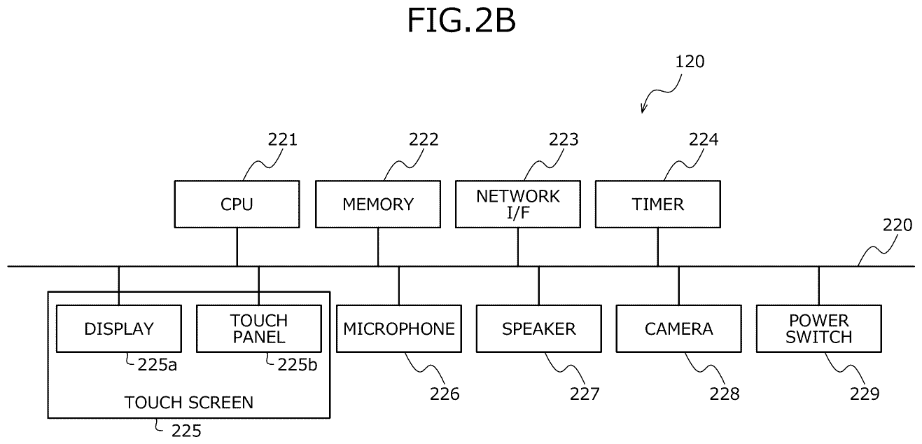

In FIG. 1, a correspondence education system 100 according to the embodiment of the present invention is configured by a server 110 and multiple operation terminals (learning support devices) 120. The server 110 is managed by, for example, an operator (administrator) of the correspondence education system 100. The server 110 may be implemented by a general-purpose computer device such as a personal computer (see FIG. 2A). The server 110 stores a learning material database and a subscriber database (both not depicted).

The operation terminal 120 may be implemented by, for example, a portable computer device (mobile terminal device) called a tablet computer or a tablet terminal (see FIG. 2B). The operation terminal 120 is distributed to the user of the correspondence education system 100 in advance when the correspondence education system 100 is in operation.

The operation terminal 120 is equipped with a touch screen composed of a display and a touch panel (see FIG. 2B). The operation terminal 120 can be operated using a predetermined operation member 130. Specifically, for example, when a capacitive or pressure-sensitive touch panel is used, the operation member 130 may be implemented by a capacitive touch pen (stylus pen) or the user's finger.

Specifically, for example, when an electromagnetic induction type touch panel is used, instead of the stylus pen, the predetermined operation member 130 may be implemented by a dedicated electronic pen called a digitizer stylus (hereinafter, as appropriate, referred to as a “digitizer”). The operation member 130 implemented by the digitizer is equipped with a writing unit that outputs a writing signal and an erasing unit that outputs an erasing signal.

The operation terminal 120 determines the type of the operation member 130 and designated objects in response to a switching operation and performs an operation according to the determined type. Specifically, the operation terminal 120 determines, for example, the type of the operation member 130, such as a stylus pen, a finger, or a digitizer, and determines whether the object is a writing action, a mouse (selection action), an eraser (erasing action), or unknown.

The operation terminal 120 is operated using a dedicated pen such as a digitizer or a stylus pen as the operation member 130 and thus, even if the user has his/her hand in contact with the touch screen when inputting a handwritten answer, the input handwritten characters can be recognized to allow the user to input handwritten characters in a natural manner without difficulty.

The server 110 and each operation terminal 120 are connected to each other so as to be able to communicate with each other via a network 140 such as the Internet. Each operation terminal 120 can perform wireless communication between a radio wave repeater provided on the network 140, for example, by a wireless LAN such as Wi-Fi (registered trademark), thereby achieving good portability of the operation terminal 120.

FIG. 2A is an explanatory diagram depicting an example of a hardware configuration of a computer device implementing the server 110. In FIG. 2A, the computer device implementing the server 110 includes a CPU 211, a memory 212, and a network interface (I/F) 213. The various units 211 to 213 included in the computer device are connected to each other via a bus 210. The CPU 211 functions as a control unit responsible for overall control of the computer device implementing the server 110.

The memory 212 stores therein programs such as a boot program and data constituting various databases. For example, the memory 212 stores therein various databases such as a learning material database and a subscriber database described later. The various databases are stored in a non-volatile storage medium among various storage media constituting the memory 212, the stored contents of the non-volatile storage medium is not erased even when the power is turned off.

The memory 212 is used as a work area of the CPU 211. The memory 212 may be implemented by, for example, a read-only memory (ROM), a random-access memory (RAM), a hard disk drive (HDD), or a hard disk (HD).

The network I/F 213 is connected to the network 140 such as the Internet and is connected to an external device such as the operation terminal 120 via the network 140. The network I/F 213 is responsible for an interface between the network 140 and the computer device constituting the server 110, and controls the input and output of data between the computer device constituting the server 110 and external devices.

FIG. 2B is an explanatory diagram depicting an example of a hardware configuration of the computer device implementing the operation terminal 120. In FIG. 2B, the computer device implementing the operation terminal 120 includes a CPU 221, a memory 222, a network I/F 223, a timer 224, a touch screen 225, a microphone 226, a speaker 227, a camera 228, and a power switch 229. The respective units 221 to 229 included in the computer device implementing the operation terminal 120 in the correspondence education system 100 according to the embodiment of the present invention are connected to each other via a bus 220.

The CPU 221 functions as a control unit responsible for the overall control of the operation terminal 120. The memory 222 stores therein various data such as a program such as a boot program and a password for startup. The memory 222 is also used as the work area of the CPU 221. The memory 222 may be implemented by, for example, a flash memory.

The network I/F 223 is connected to the network 140 such as the Internet via a radio wave relay device such as a Wi-Fi router (not depicted). The network I/F 223 controls the input and output of data with an external device such as the server 110 via the network 140.

The timer 224 measures (counts up) the elapsed time from the start of measurement. Specifically, for example, the timer 224 measures the elapsed time from the start of displaying a character (sample) requiring handwritten input. Alternatively, the timer 224, for example, may measure the elapsed time from the start of writing a handwritten character or a stroke of the handwritten character to the completion of writing.

The touch screen 225 includes a display 225a and a touch panel 225b. The display 225a displays, for example, a character (sample) that is to be input handwritten, and images related to a frame indicating an area in which the character is to be handwritten (hereinafter, as appropriate, referred to as an “answer input frame”).

The display 225a may be implemented, for example, mainly by a liquid crystal display (LCD), an electro-luminescence (EL) display, or the like. The display 225a may be a color display or a monochrome (black and white) display.

The touch panel 225b is layered on a display surface side of the display 225a and outputs, to the CPU 221, a signal corresponding to an operation position. The touch panel 225b determines, for example, the presence or absence of an input operation on the touch panel 225b, the position on the touch panel 225b where the input operation is received, and the medium on which the input operation is made, and outputs a signal corresponding to the received input operation to the CPU 221.

For example, the touch panel 225b outputs different types of signals depending on the medium used for the input operation. The CPU 221 may determine whether the medium used for the input operation is a human hand or the operation member 130 based on the difference between the amount of static electricity when the human hand touches the touch panel 225b and the amount of static electricity when the operation member 130 touches the touch panel 225b. The touch panel 225b is not limited to an electrostatic capacity type, and various known types may be used, such as an electromagnetic induction type, a resistive film type, an acoustic pulse recognition type, an ultrasonic surface acoustic wave type, an infrared light blocking type, and an image recognition type.

The touch screen 225 may be implemented by a multi-touch screen capable of receiving multi-touch operations in which multiple points on the touch panel 225b are touched simultaneously, among touch screens accepting operations by the user touching the touch panel 225b.

The multi-touch screen can receive, for example, a pinch-out operation in which a space between tips of two fingers, such as a thumb and index finger, are broaden while the tips are in contact with the touch panel 225b, or a pinch-in operation in which the space between the tips of the two fingers are shortened. By implementing the touch screen 225 by the multi-touch screen, complex input operations can be accepted without using a keyboard.

In the touch screen 225, when the touch screen 225 detects contact of the operating member 130 with the touch panel 225b while displaying a character (question) requiring handwritten input on the display 225a, even when the detected contact position is not within the answer input frame, as long as it is within a specified area on the touch panel 225b, handwritten information such as a handwritten character visualizing the position contacted by the operating member 130 may be displayed on the display 225a.

Thus, the touch screen 225 may receive input (writing) of any handwritten characters such as notes by the user on the touch panel 225b and display such as received handwritten character input, as handwritten information the display 225a. The operation terminal 120 may store any handwritten characters such as notes by the user to the memory 222.

Each time the operation terminal 120 receives input of information such as handwritten characters, the operation terminal 120 generates image data of the input handwritten characters and generates handwritten information for transmission, associating identification information of the study content (characters) at the time the handwritten characters were input and identification information of the operation terminal 120, the operation terminal 120 transmitting the generated image data and handwritten information to the server 110 each time the operation terminal 120 generates handwritten information for transmission. When the server 110 receives the handwritten information for transmission, the server 110 associates the handwritten information included in the information with the identification information of the study content and the identification information of the operation terminal 120 included in the handwritten information for transmission, and stores the associated information to the memory 222.

The handwritten information for transmission may be stored in the memory 222 for a certain period of time, such as until a certain amount of data is reached or until the learning of one learning content is completed, and then transmitted to the server 110 at the timing when the certain amount of data is reached or when the learning of one character is completed.

The microphone 226 performs analog/digital conversion of a voice such as a speaker's voice input as analog data and generates digital audio data. The microphone 226 is used, for example, when learning pronunciation in an English class. The speaker 227 performs digital/analog conversion of the digital audio data and outputs audio by passing electricity through a coil in a speaker cone based on the analog audio data. The speaker 227, for example, outputs messages such as “Try pressing a little harder” or “You did it well”. More specifically, the speaker 227 may output audio such as a warning alarm.

The camera 228 captures an image of an object by operating the touch panel 225b, generating image data. The generated image data may be stored in the memory 222. The network I/F 223 is connected to the network 140 such as the Internet and serves as an interface for communication with the server 110 via the network 140.

The power switch 229 switches ON/OFF the power supply from a power source which is not depicted to each part of the operation terminal 120. The power switch 229 switches ON/OFF the power supply on a side nearest the power source (most upstream side) of the power path from the power source which is not depicted to each part of the operation terminal 120. The power switch 229 outputs an ON/OFF signal to the CPU 221 in response to a received operation. The power switch 229 may switch ON/OFF the power supply by stopping or releasing the power supply from the power source on the most upstream side of the power path.

The learning material database stores therein learning content related to learning handwritten characters. The learning content consists of “question” content and “answer” content. The “question” content includes, for example, image data depicting a sample of a character to be learned (handwritten character to be input). The sample may be any of numbers (e.g., Arabic numerals), the alphabet, and characters of various nations, or may include all of them. The sample may also include multiple styles (fonts) for a single character.

The “question” content includes information concerning guiding objects, which are image data depicting the stroke order of characters for the user. The guiding object is an object guiding the user to a writing position when the user follows the stroke order of a character and includes, for example, guidance information displayed superimposed on the image data of the character, such as a star mark ( [symbol] ). As the user writes the character using the operating member 130, the guidance information ⋆ is moved and displayed one point at a time sequentially to guide the user to the next point (writing position). Corresponding to the number of strokes of the character, the guidance information [symbol] is displayed for each stroke, sequentially increasing starting from the writing starting position.

By displaying one guidance information [symbol] at the first point of a stroke (the position where writing of a character starts), the user can start writing the character from the correct position. Every time the user touches the position of one guidance information [symbol] (hit), a new guidance information [symbol] is displayed at the next position corresponding to the stroke order of the character. A predetermined notification sound may be sounded to notify the user every time the guidance information [symbol] is displayed.

By displaying multiple guidance information [symbol] 's according to the stroke order corresponding to the character, the user is guided to write the character in the correct order. The guidance information [symbol] may be initially displayed with one starting point blinking and the guidance information [symbol] at positions that the user has traced may be switched to a blinking state, thereby allowing the user to know the next positions in writing the character.

The guiding object includes directional information, such as an arrow (→), along with the guidance information. The directional information → is image data indicating the direction of stroke order for a character. The directional information → is displayed along a side part of the character, guiding the user to trace along the positions of the directional information → in the correct direction and stroke order of the character. For example, when the character has a branch (a connecting portion, an intersecting portion, etc.), the directional information → is displayed, allowing the user to proceed to write without making a mistake in the direction of stroke order at the branch.

The “question” content may include, for example, image data of the answer input frame. The answer input frame may include a solid line indicating the outer frame of the answer input frame, or a cross-shaped ruled line formed by a solid line or a dotted line thinner (or lighter in color) than the solid line. For example, the solid line indicating the outer frame of the answer input frame may form a square and the ruled line may form a cross which divides the square into four equal parts.

Furthermore, the “question” content may include messages such as “Try writing this character”, “Try tracing the example.” etc. The message may be in the form of text, audio, or both.

The “question” content is in a playable format and can be played back using a question playing application installed on the operation terminal 120 and is composed of various types of data such as characters (text), still images, and audio. The “question” content may include video data (video such as animated images and audio). The “question” content may have different levels of difficulty depending on the user's level of proficiency.

In the learning content, each character to be learned is assigned unique identification information. The unique identification information is information that identifies the character to be studied and as described below, the unique identification may be used to keep track of the user's progress in learning. The unique identification information may be assigned only to the “question” content, only to the “answer” content, or to the learning content including the “question” content and the “answer” content.

The “answer” content includes information for judging whether the user traces the characters in the correct stroke order. For example, when the user writes a character, the parts that the user traces (hits) using the operating member 130 along with the guidance information [symbol] and the direction information → that are sequentially displayed as guiding objects in the “question” content is kept as a handwriting object.

Characters are written by tracing each stroke continuously in one stroke. Thus, the “answer” content enables judgement of the pen pressure when the user writes each stroke (one stroke). When the guidance information [symbol] is hit, the pen pressure at the hit point is judged and a pen pressure object according to the pen pressure, e.g., pen pressure object A or pen pressure object B, is displayed.

For example, when the pen pressure at the point of the guidance information [symbol] is at least equal to a predetermined pen pressure that exceeds a lower limit of the threshold for pen pressure judgment, the guidance information [symbol] at the traced position is left displayed as the pen pressure object A. On the other hand, when there is a position (point) where the pen pressure of tracing is less than the lower limit of the threshold for pen pressure judgment, this point where the pen pressure is weak is displayed differently from the guidance information [symbol] , e.g. as a gray circle mark (∘), as the handwriting object B. The pen pressure object A may be displayed such as a predetermined mark different from the guidance information [symbol] and the pen pressure object o.

Furthermore, if the tracing position deviates from the guidance information [symbol] on the characters or if the operating member 130 is released midway, the “answer” content highlights the stroke count portion of the character being written, for example with a red dotted line and guides the user to write each stroke in one stroke.

The “answer” content includes information concerning a predetermined threshold for judging the pen pressure. The threshold for judging the pen pressure is a benchmark value for determining whether the pen pressure of a character handwritten by the user is an appropriate pen pressure and may be any value set, for example, within a range between “0 (zero)” where no pressure is applied from the specified operating member 130 to the touch panel 225b and “100” where the pressure is the maximum value at which the pressure can be judged to be appropriate. The threshold for judging the pen pressure is a relative value to the actual measured value of the pressure applied from the specified operating member 130 to the touch panel 225b, and a specific pressure (value) corresponding to “0” or “100” may be set arbitrarily.

The threshold for judging the pen pressure may be set to one or multiple levels. When the threshold for judging the pen pressure is set to multiple levels, for example, the lower limit of the threshold for judging the pen pressure may be set to “50”, an intermediate value of the threshold for judging the pen pressure may be set to “75”, and an upper limit of the threshold for judging the pen pressure may be set to “100”.

The threshold for judging the pen pressure may be set for each character or for each stroke in the character. The threshold for judging the pen pressure may be set for pen pressure in the character or for each writing part in the stroke of the handwritten character, for example.

The “answer” content includes image data (font) of a character which constitutes the answer used to judge the pattern of handwritten character input in response to a request from the “question” content. Characters constituting answers correspond to the “question” content and may be numbers (e.g. Arabic numerals), the alphabet, or characters of various nations. The characters constituting answers may be any image data of various fonts, depending on the “question” content. In the “answer” content, various thresholds for judging pen pressure may be set depending on the fonts.

The “answer” content may include information regarding judgment criteria such as the stroke order of the characters constituting answers.

The “answer” content includes information about whether the user has correctly written one character of multiple strokes. For example, when all the strokes of the character have been written by tracing along the guiding object with the predetermined pen pressure or greater, a voice saying “You wrote it well” is output, and the written character is played back as an animated image or the like. When the pen pressure during tracing is below the lower limit of the threshold for judging the pen pressure in any part, the part where the pen pressure is weak is displayed as o, and a voice saying “Try pressing harder next time” is output. On the other hand, for example, when the user deviates away from the position of the guidance information [symbol] of the guiding object, a voice saying “You traced it wrong” is output, and the guiding object of the corresponding number of strokes is displayed again.

The “answer” content may include text data instead of, or in addition to, image data (fonts) of the characters (numbers, alphabet, etc.) constituting the answers.

In the learning material database, the “answer” content is each stored associated with “question” content. In the learning material database, each “answer” content is stored associated with one “question” content. In the learning material database, at least one “answer” content is stored associated with each “question” content.

The subscriber database stores learning progress information associated with each user's identification information. The learning progress information indicates the progress of learning. The learning progress information may be implemented, for example, by information concerning the playback history of learning content. The learning progress information may be implemented, for example, by information concerning the “question” content that has been displayed on the display 225a of the operation terminal 120 or the “question” content where the input of answers has been received.

Information on the learning progress may include, for example, identification information of the learning content whose proportion exceeding a threshold for: determining the playing of the learning content, an input acceptance of answers, and rewriting, is determined to be above a predetermined proportion, and information concerning the date and time when: the learning content is played, the learning content is displayed, the input of answers is accepted, and the above-mentioned determination was made (hereinafter as appropriate, referred to as the “learning date and time”).

Thus, by managing the learning progress of each user, each user can learn appropriate characters according to the learning progress of the user. The subscriber database may store information concerning the users themselves, such as names (member names), grades, and dates of birth of users who are subscribers to the correspondence education system 100. The subscriber database may also include information concerning the users' guardians, such as the users' parents.

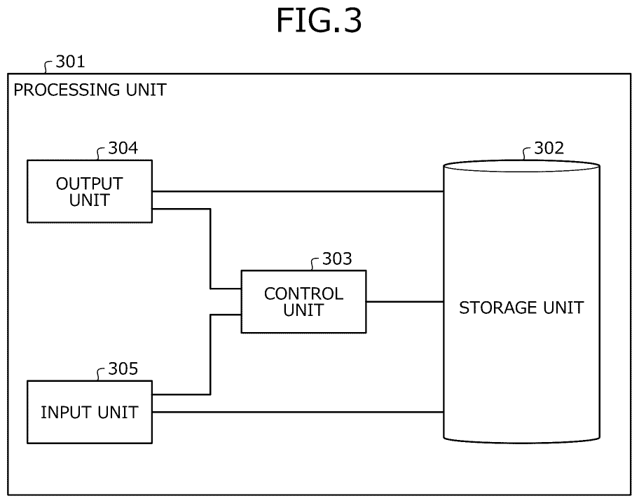

A functional configuration of the operation terminal 120 is described. FIG. 3 is a block diagram depicting the functional configuration of the operation terminal 120. In FIG. 3, functions of the operation terminal 120 may be implemented by a processing unit 301. The processing unit 301 includes a storage unit 302, a control unit (recognition unit, determination unit) 303, an output unit 304, and an input unit 305.

The storage unit 302 stores therein the learning material database mentioned above. For example, the storage unit 302 may store only the learning content that the user has downloaded from the server 110 among the learning material database stored in the server 110. The storage unit 302 may store therein, for example, out of the learning content downloaded by the user from the server 110, the learning content downloaded during a period going back to predetermined time prior to the current time.

The storage unit 302 stores therein information concerning handwritten characters. The information concerning handwritten characters input by the user includes image data of the handwritten input characters and information concerning the stroke order of the characters and the pen pressure. The information concerning the stroke order of the characters may be implemented by the guidance information ⋆ and directional information that provides guidance on the stroke order of the corresponding character by display, and the information on whether the user traces the character along the guiding object with a predetermined pen pressure or more. The information concerning the pen pressure of the characters may be information such as whether the proportion of the pen pressure of the character received by handwritten input below the lower limit of the threshold for judging the pen pressure is not more than a predetermined proportion, or a numerical value of the proportion below the lower limit of the threshold for judging the pen pressure.

The information concerning the handwritten characters input by the users may include at least any one of the date and time when the characters were handwritten, the number of times the characters were handwritten, etc. The information concerning the handwritten characters input by the users may further store data about the stroke order of the characters handwritten by the users. The storage unit 302 stores therein, for example, the information concerning the handwritten characters in association with unique identification information of the learning content.

The storage unit 302 stores, for example, the identification information of the operation terminal 120, the information concerning the user, and a password used for starting up and operating the operation terminal 120. In this embodiment, the functions of the storage unit 302 may be implemented by the memory 222.

The control unit 303 controls the output unit 304 to set questions for the user. Specifically, the output unit 304 may be implemented by the display 225a. Specifically, the control unit 303, for example, sets questions by displaying the characters (samples) requiring handwritten input and the answer input frames on the display 225a.

More specifically, the control unit 303, for example, sets questions by displaying the character (sample) required to be handwritten, within the answer input frame, in an appropriate size for the answer input frame. In this case, the control unit 303 displays the guiding object (the guidance information [symbol] and the directional information →) indicating the stroke order of the character. This allows the user to learn the characters by tracing the displayed guiding object as a sample.

For example, the control unit 303 may set a question by displaying the characters (samples) requiring handwritten input next to the answer input frame. This allows the user to learn the characters by writing the characters in a way that imitates the characters (samples) while looking at the displayed characters (samples).

In addition to the characters (samples) requiring handwritten input and the answer input frame, the control unit 303 may display, for example, on the display 225a, messages such as “Try tracing the character on the screen” or “Try writing the character on the screen”, or illustrations that may encourage or pique the user's (e.g., a child's) interest to learn characters.

Specifically, the output unit 304 may be implemented by the speaker 227 in addition to the display 225a. In this case, the control unit 303 may specifically, for example, display on the display 225a the characters (samples) requiring handwritten input and the answer input frames as well as output messages such as “Try tracing the characters on the screen” or “Try writing the characters on the screen” by voice from the speaker 227.

The control unit 303 controls the input unit 305 to accept the handwritten input of characters by the user as an answer to the question set via the output unit 304. Specifically, the input unit 305 may be implemented by the touch panel 225b. The control unit 303 controls the input unit 305 to accept the input operation on the touch panel 225b by such as the user, obtains, from the touch panel 225b, a signal corresponding to the accepted input operation. In this embodiment, the functions of the control unit 303 may be implemented by the CPU 221 and the memory 222.

For example, when the handwritten input of characters is performed using a dedicated electronic pen such as the digitizer as the operation member 130, the control unit 303 may recognize the handwritten characters which are input or the strokes of the handwritten characters. This enables recognition of only the handwritten characters even when the user is touching the display 225a with his/her hand.

The control unit 303 recognizes the handwritten input of characters and holds the portion traced on the guiding object as a handwriting object. The control unit 303 judges, based on information for judging the stroke order of each character whether the stroke order of the held handwriting object is correct or incorrect.

Specifically, for example, in a case where the user traces the entire character from the top along the guidance information [symbol] of the guiding object, the stroke order of the handwriting object is judged to be correct. For example, the control unit 303 determines, based on the pen pressure information, whether the user traces the entire character from the starting point to the ending point in a single stroke with at least a predetermined writing pressure for each stroke of the character.

For example, the control unit 303 judges the stroke order to be incorrect when the user traces a position away from the guidance information ⋆ or traces a connecting position in a direction different from the direction information →. For example, the stroke order is judged based on the tracing state (the deviation of the handwriting object from the guidance information [symbol] ) for each point (guidance information [symbol] ) displayed sequentially as a guiding object. The control unit 303 may judge the stroke order and pen pressure for each stroke or for each character.

For example, the control unit 303 judges the stroke order of the character to be correct when the handwriting object is traced along the guiding object (guidance information ⋆ and directional information →), and judges the stroke order to be incorrect when the handwriting object does not follow the guiding object, and the control unit 303 outputs information concerning the judgment result.

For example, the control unit 303 may display a message such as “You wrote it well” on the display 225a when the judgment result is that the stroke order is correct according to the sample, and the control unit 303 may display a message such as “You're tracing in the wrong order” to prompt the user to rewrite the character when the stroke order is incorrect.

The control unit 303 recognizes the handwritten input of characters and judges the pen pressure of the recognized handwritten characters. Based on a threshold for judging writing pressure, the control unit 303 determines whether the pen pressure of the recognized handwritten characters is at least equal to the threshold for judging the pen pressure, or the pen pressure of the recognized handwritten characters is below the threshold for judging the pen pressure. For example, the control unit 303 judges the pen pressure of the consecutive handwritten objects for each piece of guidance information.

When multiple threshold levels for judging the pen pressure are set, the control unit 303 determines whether the pen pressure of the recognized handwritten characters is at least equal to each threshold for judging the pen pressure or is below the threshold for judging the pen pressure.

Specifically, for example, when the lower limit of the threshold for judging the pen pressure is set to “50” and the intermediate value of the threshold for judging the pen pressure is set to “75”, the control unit 303 judges the pen pressure to be too weak when the pen pressure of the characters received as handwritten input is “0 to 49”, which is below the lower limit “50” of the threshold for judging the pen pressure.

The control unit 303 judges that the pen pressure is “not too weak, but could be a little stronger” in a case when the pen pressure of the characters accepted as handwriting input is at least equal to “50”, which is the lower limit of the threshold for judging the pen pressure, but less than the intermediate value “75” of the threshold for judging the pen pressure, i.e., is in range of “50 to 74”. When the pen pressure of characters accepted as handwritten input is at least equal to the intermediate value “75” of the threshold for judging the pen pressure, i.e., is in a range of “75 to 100”, the control unit 303 judges the pen pressure to be “good”.

The control unit 303 controls the output unit 304 based on the judgment result of the pen pressure of the recognized handwritten characters and outputs information regarding the judgment result.

The control unit 303 outputs information regarding the judgment result, for example, by displaying, on the display 225a, a line whose thickness varies depending on the pen pressure of the recognized handwritten character or the pen pressure of a single stroke of the handwritten character, along the trajectory traveled by the tip of the digitizer.

Specifically, the control unit 303 displays, on the display 225a, the recognized handwritten characters or strokes of the handwritten characters so that, for example, the greater is the pen pressure, the thicker are the lines, and the lower is the pen pressure, the thinner are the lines. This allows the user to visually recognize the pen pressure of the handwritten characters or strokes written by the user in an easily understandable manner.

For example, when the pen pressure of tracing is at least equal to the threshold for judging the pen pressure, the control unit 303 keeps the display of the guidance information [symbol] as the handwriting object [symbol] in a lighted state. On the other hand, when there is a portion where the pen pressure of the traced stroke is below the threshold for judging the pen pressure, the control unit 303 displays the corresponding portion as a handwriting object o in a display state different from that of the guidance information [symbol] . The control unit 303 may change the size of the handwriting object mark ( [symbol] , ∘) displayed on the display 225a, depending on the pen pressure.

The control unit 303 may recognize the handwritten input of characters for each stroke, judge the pen pressure of the recognized stroke, and output information concerning the judgment result. That is, before the input of one character is completed, each time the input of a single stroke is received, the stroke may be recognized, the pen pressure of the recognized stroke may be judged, and the stroke may be displayed having a thickness depending on the pen pressure.

The control unit 303 may judge, for example, the pen pressure at the part where the digitizer comes into contact with the touch panel 225b to start writing (starting point), the pen pressure at the part where the digitizer leaves the touch panel 225b (ending point), and the pen pressure between the starting point and the ending point.

The control unit 303 may determine whether the proportion at which the pen pressure of the recognized handwritten character or stroke of the handwritten character exceeds the threshold for determining rewriting set for the handwritten character or the stroke, is at most the predetermined proportion. The threshold for determining rewriting, for example, may be a lower limit of the threshold for judging the pen pressure.

The proportion of the pen pressure of the recognized handwritten character or stroke of the handwritten character exceeding the threshold for determining rewriting (i.e., the predetermined proportion) and set for judging whether the pen pressure is appropriate may be set to any value, such as, for example, “40%”. For example, when this predetermined proportion is set for one handwritten character, the control unit 303 determines, at the stage when the writing of one character is completed, whether during writing of the character, the proportion of the pen pressure that exceeds the threshold for determining rewriting is over 40% or is not more than 40%.

For example, when the predetermined proportion above is set for the strokes, the control unit 303 determines, at the stage when the writing of one stroke is completed, whether during the writing the one stroke, the proportion of the pen pressure that exceeds the threshold for determining rewriting is over 40% or is not more than 40%.

In a case that the proportion that the pen pressure of the recognized handwritten character or stroke of the handwritten character exceeds the threshold for determining rewriting is not more than the predetermined proportion (e.g. 40%), the control unit 303 may erase the display of the handwritten character or stroke most recently input and request the handwritten character or stroke most recently input to be rewritten.

In this case, the control unit 303 may display a message prompting the user to rewrite, such as “Try pressing harder” or “Try pressing a little harder”, on the display 225a. Alternatively, in this case, the control unit 303 may output an audio message from the speaker 227 prompting the user to rewrite, such as “Try pressing harder” or “Try pressing a little harder”. In particular, prompting the user to rewrite by audio together with the display allows the user to surely know that the pen pressure was insufficient.

Messages that prompt rewriting and that are output via the display 225a or the speaker 227 may be, for example, “Please press a little harder”, “Try pressing harder again”, “Try writing the same character again. This time, please press harder than before”.

The messages prompting rewriting and output via the display 225a or the speaker 227 may be, for example, “Put some effort into writing”, “Try writing thicker,” or “Put your hand on the tablet”, depending on the age of the user, for example. On the other hand, when the user is a child such as a preschooler or a child in the lower grades of elementary school, the message “Put some effort into writing” may raise concerns that the pen pressure will not become strong enough just by the user gripping the pen strongly, the message “Try writing thicker” may raise concerns that the user will not know how to write thickly, and the message “Put your hand on the tablet” may raise concerns that the user will apply low pen pressure even if the user places his or her hand on the tablet. Therefore, the content of the messages may be varied depending on the age of the user.

The message output via the display 225a or the speaker 227 may be, for example, “Writing pressure for the vertical stroke is weak”, “Writing pressure for the dots needs to be a little stronger!”, or “Writing pressure for the character is low (high)”, for content pointing out strokes that the user is thought to have difficulty with.

The messages output via the display 225a or the speaker 227 may, for example, have content notifying that the pen pressure is appropriate, such as “Writing pressure is just right” or “That's it!”. Furthermore, the messages output via the display 225a or the speaker 227 may have, for example, the content notifying a specific numerical value regarding the pen pressure, such as “Your writing pressure is xx %”.

The messages output via the display 225a or the speaker 227 may, for example, have content indicating that the pen pressure is too high, such that “Please write with less pressure” or “Please write more gently”. Alternatively, in a case where specifications allow for the input of both handwritten characters written by a finger and handwritten characters written by a digitizer to be accepted, the messages may, for example, have content indicating the difference in the tendency of pen pressure for each operating member 130, such as “Your finger pressure is too weak” or “Your digitizer pressure is too strong”.

The control unit 303 may continue to display the handwritten characters or strokes input immediately before while outputting the audio message prompting the user to rewrite and may erase the display of the handwritten characters or strokes after the output of the audio message prompting the user to rewrite is completed and then, accept rewriting of the handwritten characters or strokes. In this case, even after the output of the audio message prompting rewriting is completed, the display of the messages prompting rewrite may continue, and after the output of the audio message prompting rewriting is completed, the display of the handwritten characters or strokes may be erased and rewriting of the handwritten characters or strokes may be accepted.

The control unit 303 may further determine whether the handwritten input of character is similar to a sample character to such an extent enabling recognition. Specifically, the control unit 303 performs pattern recognition on the handwritten input of the character and can determine whether the character based on the handwritten input of character is similar to the sample character to such an extent that the character can be recognized, based on a pattern-recognized (character) and a pre-stored character (sample).

The control unit 303 may, for example, extract determination target portions in the shape of the handwritten character and determine whether the handwritten character input is similar enough to be recognized as a sample character, based on, for example, the degree of deviation between the determination target portions and determination target portions in the sample shape, and the number of determination target portions that are determined to have a deviation of a predetermined amount or more.

The control unit 303 may determine whether the handwritten character input is similar enough to be recognized as the sample character, based on, for example, whether parts to be straight are written straight. The control unit 303 may determine whether the handwritten character input is similar enough to be recognized as the sample character, for example, based on whether the handwritten character input is well-balanced against the size of the answer input frame.

The control unit 303 determines whether the handwritten character input is in accordance with the guidance information ⋆ and direction information → of the sample guiding object, based on the stroke order of the handwritten character as well as the shape of the handwritten character input. For example, the control unit 303 compares the sample shape and stroke order of the characters to be compared with the shape and stroke order of the handwritten character input. Then, a judgment is made as to whether the handwritten character input is written literally in accordance with the sample character, based on the deviation between the shape of the handwritten character and the sample shape (the position of the guidance information ⋆) and the deviation between the stroke order of the handwritten character and the stroke order of the character to be compared.

Determining compliance regarding the stroke order of the handwritten character enables not only the shape of handwritten character but also the stroke order to be learned. Determining compliance regarding the stroke order of the handwritten character enables determination of whether the handwritten character input is similar enough to be recognized as the sample character, based on the movement of the operating member 130, even when the handwritten character is slightly cursive and deviates from regular script. This allows the user to pay attention to writing the characters with the appropriate pen pressure without reducing the user's motivation to learn.

The control unit 303 may control the output unit 304 to output the judgment result of the handwritten character. For example, when the handwritten character input is not similar enough to be recognized as the sample character or the strokes are excessively meandering, the control unit 303 controls the output unit 304 to output messages urging the user to rewrite the character, such as “Try writing it again”.

In a case that the handwritten character input is not similar enough to be recognized as the sample character or the strokes are excessively meandering, the control unit 303 may display an input field for the user to re-input the handwritten character. Specifically, the control unit 303 may, for example, control the output unit 304 to display the input field for inputting the handwritten character again next to or near the answer input frame initially displayed.

The control unit 303 may display the sample in the answer input frame where the user is to re-input the handwritten characters. That is, the sample is initially displayed next to the answer input frame for handwritten input of the character, and the sample is displayed in the answer input frame where handwritten character is to be input again when rewriting of the handwritten character or stroke is required.

In this case, the control unit 303 may display the sample characters in a lighter color than the color of the handwritten characters in the answer input frame where the handwritten input is to be performed again. Alternatively, the control unit 303 may display the sample characters in the answer input frame for re-inputting a handwritten answer in a color (e.g. “gray” or “blue”) different from the color (e.g., “black”) of the characters displayed during initial handwritten input of the answer.

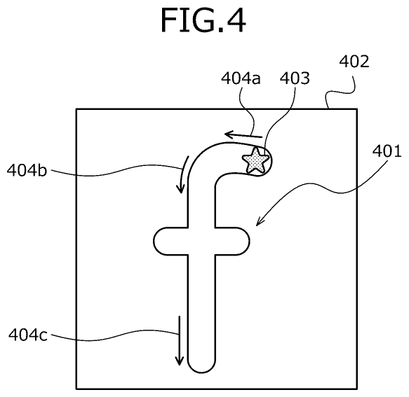

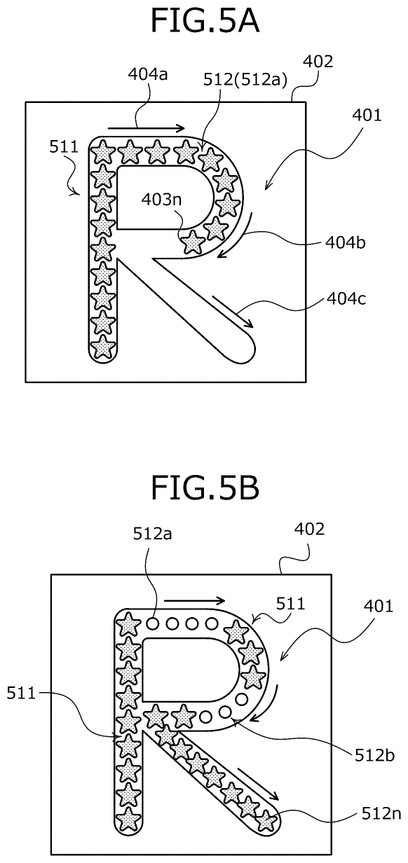

Examples of character display screens displayed on the display 225a by the operation terminal 120 are described. FIGS. 4, 5A, and 5B are explanatory diagrams depicting examples of a stroke order display screen displayed on the display 225a by the operation terminal 120.

As depicted in FIG. 4, the operation terminal 120 displays, on the display 225a, a sample 401 of a character to be learned (a handwritten character to be input) and an answer input frame 402, based on the “question” content. FIG. 4 depicts a state in which the lowercase alphabet letter “f” is displayed as the sample 401 on the display 225a, as the “question” content.

The character “f” in the sample 401 has a total of two strokes and guidance information 403 ( [symbol] ) of the guiding object is displayed at the starting position of the first stroke depicted in FIG. 4, and one or more pieces of directional information 404 (→) are displayed to indicate the direction in which to trace the first stroke in one stroke. For example, in the character “f”, the second stroke crosses the direction in which the first stroke is traced and in this case, multiple pieces of directional information 404 (404a to 404c) are displayed on the sides of the character, correctly guiding the user in the direction in which the first stroke is to be traced.

The sample 401 is displayed, for example, in a lighter color than the outer frame of the answer input frame 402. This allows the user to visually recognize the characters that are to be handwritten without the user being disturbed by the sample 401 and enables the user to learn writing the characters.

In the example depicted in FIG. 4, the user is prompted to input (write) handwritten characters by using the dedicated electronic pen such as the digitizer as the operating member 130 to write a sample 401 “f” by starting to trace the sample 401 from the position of the guidance information 403 ( [symbol] ).

FIGS. 5A and 5B depict writing states of a second stroke of the upper case alphabet letter “R” as the sample 401 set as the “question” content. In the sample 401, the total number of strokes of the character “R” is two. In the state depicted in FIG. 5A, the first stroke of the character “R” of the “question” content has been traced and is displayed and held as a handwriting object 511 of the first stroke.

FIG. 5A depicts a display state in which the user is guided to a midway position of the second stroke of the character “R” by guidance information 403n ( [symbol] ). The guidance information 403n ( [symbol] ) indicates the user's latest tracing position. The user can write the second stroke by tracing the character along the guidance information 403 ( [symbol] ), following the direction information 404a (→) sequentially displayed. The display state of the guidance information 403 ( [symbol] ) at the positions where the user traced the previous stroke is displayed and held as a handwriting object 512 of the second stroke by the user tracing the character along the guidance information 403 ( [symbol] ) without straying.

Specifically, when the user traces and writes a guidance information 403n portion, the guidance information 403n being a point at the latest position (leading end), the operation terminal 120 repeatedly displays new subsequent guidance information 403n until the ending position of the second stroke is reached. Here, at each point, when the stroke order and writing pressure are normal, a sound effect (SE) indicating such may be output.

Multiple pieces of directional information 404a to 404c are displayed as the guiding objects, so that the user can trace and write the second stroke without making a mistake in terms of the direction. The character “R” has a part connected to the first stroke, and multiple pieces of correct directional information 404a to 404c are displayed during writing of the second stroke thereby, enabling the user to continue to trace and write in the correct direction by following the display of the new guidance information 403n.

Subsequently, as depicted in FIG. 5B, the second stroke of the character “R” is completed. As depicted in FIG. 5B, the state in which the user has traced along the guidance information 403 is stored as the handwriting objects 511 and 512. A handwriting object 512a is the starting position of the second stroke, and a handwriting object 512n is the ending position of the second stroke.

During tracing, the operation terminal 120 displays, on the display 225a, the lines (strokes) in different thicknesses depending on the pen pressure of the handwritten character or strokes of the handwritten character.

Configuration may be such that the operation terminal 120 displays the lines in different thicknesses depending on the pen pressure of the handwritten character or strokes of the handwritten character only when a specific operation member 130, such as the digitizer or an eraser, is used as the operation member 130. This allows the user to reliably learn how to adjust the pen pressure by controlling the strength of the fingers when handwriting the characters.

In the example depicted in FIG. 5B, the pen pressure of four handwriting objects 512a near the start of the second stroke and the pen pressure of three handwriting objects 512b in the middle are lower than the threshold of the pen pressure (for example, the lower limit of the pen pressure threshold “50”), and are therefore to be depicted with a shape (o) indicating low pen pressure. This allows the user to notice the pen pressure of some of the second strokes of the character “R” is weak. In this case, the operation terminal 120 may, for example, display and notify the user of a message saying “Try to press little harder” to urge the user to rewrite the character.

The operation terminal 120 may judge pen pressure of the handwritten character in multiple stages, changing the size of the shape (o) of the handwriting object 512 depending on the pen pressure of each stage. For example, for a pen pressure higher than the lower limit “50” of the threshold for judging the pen pressure, the size of the handwriting object 512 ( [symbol] ) may be displayed larger when the pen pressure is higher than the threshold “75”, and may be displayed smaller when the pen pressure is lower than the threshold “75”. For example, for a writing pressure lower than the lower limit “50” of the threshold for judging the pen pressure, the size of the handwriting object 512 (o) may be displayed larger when the pen pressure is higher than the threshold “25”, and may be displayed smaller when the pen pressure is lower than the threshold “25”.

For example, the operation terminal 120 may erase the display of the handwriting object 512 for the second stroke written immediately before and accept the rewriting of the second stroke, after completing the output of the audio message urging the user to rewrite the stroke.

In a case that the audio message urging rewriting is output according to handwritten characters, that is, in a case that the audio message urging rewriting is output when the handwritten input of one character is completed, rewriting of the character after the message urging rewriting is output may be optional. In a case that the audio message urging rewriting is output according to handwritten characters, the display color of the strokes urging rewriting may be different from the display color of the strokes that do not need to be rewritten. This allows for reliably in notifying the user of the strokes and urging rewriting.

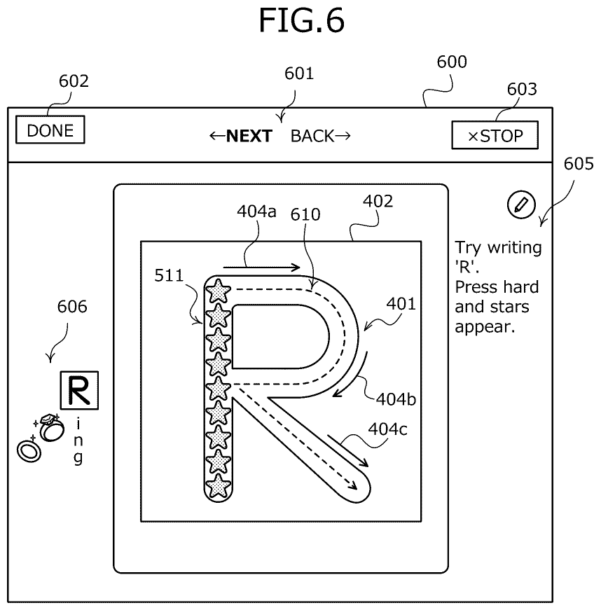

An example of application to a learning material application for learning the stroke order of characters described above is described. FIGS. 6, 7, and 8 are diagrams depicting examples of screen displays of the learning material application for learning the stroke order of characters. For example, the server 110 executes a program for the learning material application to display and output various screens for learning the stroke order of characters on the user's operation terminal 120 and to perform processing to judge, for example, the stroke order of characters, based on the characters input by the user.

As depicted in FIG. 6, the learning material application displays, on the display 225a of the operation terminal 120a, a character learning screen 600 depicting the stroke order of the uppercase alphabet letter “R”. At the top of the character learning screen 600, “Next” and “Back” selection buttons 601 for selecting the character to be learned, a “Done” button 602 for when learning of the displayed character is completed, and a “Stop” button 603 for stopping learning of the character are displayed.

The character learning screen 600 displays, as “question” content for learning a stroke order sample, the sample 401 of the character “R” in the answer input frame 402. The character learning screen 600 displays, as learning content 605 for the “question” content, “Try writing ‘R’. Press hard and stars appear.”, guiding the user on how to write the character. The character learning screen 600 displays the character and illustration of an example 606 depicting an object “Ring” including the sample 401 of the character “R” as “question” content.

The character learning screen 600 depicted in FIG. 6 is in a state where, for example, the user has written the first stroke of the character “R” in the correct stroke order and with adequate pen pressure, and the operation terminal 120 displays the handwriting object 511 of the first stroke of the character “R” with a star. In this state, the operation terminal 120 guides the user the correct stroke order for the second stroke of the character “R” that the user is about to write, for example, by highlighting the second stroke with a red dotted line as a highlighted display 610.

The highlighted display 610 displays the correct stroke order of the character “R” from the starting point to the end point in sequence as an animated image of red dots and outputs the animated image with SE.

For example, if a point occurs where the pen pressure is low, such as when the operating member 130 is released halfway through writing the second stroke of the character “R,” a voice may be output advising the user to “keep writing until the end” and urging the user to rewrite it.

In a case that the operation terminal 120 judges that the stroke order of the character is incorrect or that some of the pen pressure is low, the highlighted display 610 such as the red dotted line may be displayed as the animated image and output with SE, and the correct stroke order can be presented to the user by the highlighted display 610. At this time, the operation terminal 120 notifies the user by a message or audio output on the character learning screen 600 saying “Try writing it again” to urge the user to rewrite the character.

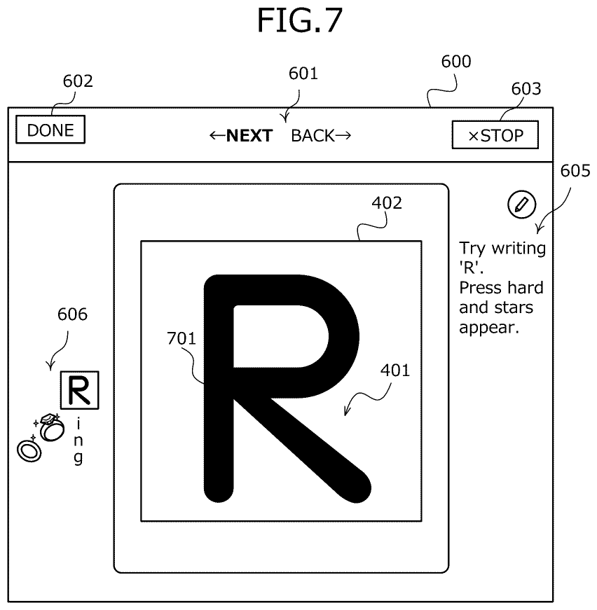

The example depicted in FIG. 7 is the display state of the character learning screen 600 immediately after the user has finished writing the character “R”. In a case that the user has finished writing the character “R” in the answer input frame 402, the operation terminal 120 displays the character “R” again, for example, in black, in an animated image 701 with the correct stroke order. The reading of the character “R” is output as a voice to notify the user. For example, the voice may pronounce the character as “‘R’ as in Ring” corresponding to an example 606.

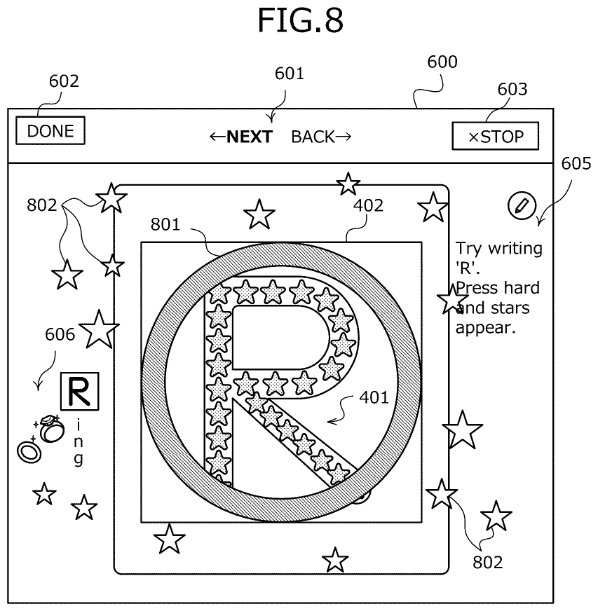

After the display depicted in FIG. 7, the operation terminal 120 displays a presentation screen related to judging the stroke order of the character depicted in FIG. 8. When the user finishes writing the character “R”, the operation terminal 120 displays the display screen for the character “R” depicted in FIG. 8. When the operation terminal 120 judges that the character “R” has been traced in the correct stroke order with the correct pen pressure (the pen pressure is higher than the threshold) at all points, the operation terminal 120 outputs a voice message saying “Good job! You wrote “R” well!” as a presentation, and then plays the presentation with SE and an animated image 801, indicating the writing is correct. For example, the animated image 801 displays a circle (o) indicating that the learned character “R” on the answer input frame 402 has been written correctly. In addition, multiple decorative images ( [symbol] ) 802 such as animated images may be displayed on the outer edge of the character “R”.

In contrast, when the operation terminal 120 judges that the stroke order of the character “R” is incorrect, the operation terminal 120 displays a message urging the user to rewrite the character, for example, “Try writing it again,” as the presentation. When the operation terminal 120 judges that there are some points where the pen pressure is weak (the pen pressure is lower than the threshold), the operation terminal 120 displays a message to notify the user that the pen pressure is weak, for example, “You wrote “R”. Next time, try pressing harder.” At this time, the highlighted display 610, such as the red dotted line, described above, may be displayed as an animated image.

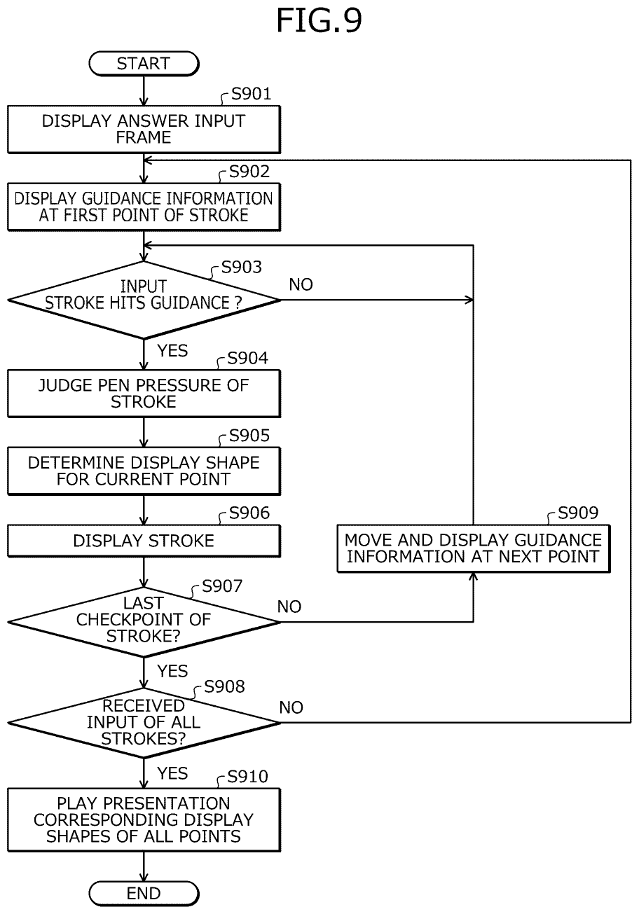

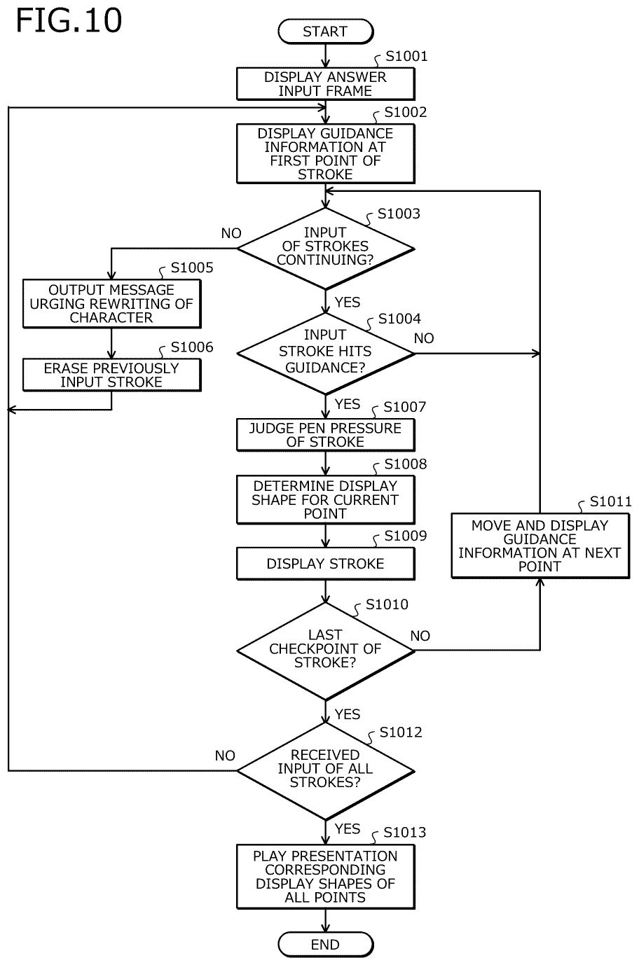

An example of a character learning process is described with reference to FIGS. 9 and 10. FIG. 9 is a flowchart depicting the example of the character learning process. The process in FIG. 9 is described as being performed by the control unit 330 (CPU 221) of the operation terminal 120. Not limited hereto, of the processes depicted in FIG. 9, the process for judging, for example, the stroke order may be executed by the CPU 211 of the server 110, and system configuration may be such that the operation terminal 120 transmits information required for the judgment to the server 110 and outputs the judgment result of the server 110, for example, by display.

In the flowchart depicted in FIG. 9, firstly, the sample 401 of the handwritten character (question) to be written and the answer input frame 402 are displayed on the display 225a, based on the question content (step S901). The guidance information (e.g., [symbol] in FIG. 4) is then displayed at the first point of the stroke of the character in the answer input frame 402 displayed at step S901 (step S902).

Next, the input of the stroke (writing of a stroke) by the predetermined operation member 130 such as the digitizer is accepted and whether the input of the stroke hits the guidance information is judged (step S903). At step S903, for example, whether the displayed guidance information portion is traced is determined.

When the result of the judgement at step S903 is that the stroke input hits the guidance information (step S903: YES), the pen pressure of the stroke hit is judged (step S904). On the other hand, when the result of the judgment at step S903 is that the stroke input does not hit the guidance information (step S903: NO), the process returns to step S903.

After the process at step S904, the display shape at the current point is determined (step S905). For example, when the pen pressure is higher than the threshold, the guidance information ( [symbol] ) is kept displayed, and when the pen pressure is lower than the threshold, the guidance information is displayed in a (o) shape indicating low pen pressure and the stroke is displayed in the determined display shape (step S906).

Then, whether the current checkpoint is the last checkpoint of the stroke is determined (step S907). For example, when the character has multiple strokes, whether the last point of one stroke has been reached is determined. When the current checkpoint is the last checkpoint of the stroke (step S907: YES), the process proceeds to step S908. On the other hand, when the current checkpoint is not the last checkpoint of the stroke (step S907: NO), the guidance information is moved to and displayed at the next point (step S909), and the process returns to step S903.

Whether the input of all strokes has been received is determined (step S908). For example, in a case where the character has multiple strokes, whether the strokes have been written up to the last point of the last stroke is determined. When the input of all strokes has not been received (step S908: NO), the process returns to step S902. On the other hand, when the input of all strokes has been received (step S908: YES), a presentation corresponding the display shapes of all points is played (step S910), and the above series of processes is terminated.

At step S910, for example, when the display shape of all points is A, a presentation is played that indicates that the entire character has been traced according to the stroke order and the pen pressure is normal and above the threshold (for example, see FIG. 8). In contrast, when the display shape of some points is ∘, a presentation is played that indicates that the entire character has been traced according to the stroke order, but at some of points, the pen pressure is low. In this case, a presentation is played, for example, as a message urging the user to rewrite the character, the message being output via the display 225a or the speaker 227.

FIG. 10 is a flowchart depicting another example of the processing procedure for character learning. In addition to the processing described in FIG. 9, the processing in FIG. 10 adds processing for a case where the user removes the predetermined operating member 130 such as the digitizer from the display 225a in the middle of a stroke. In other words, a process of determining whether each stroke is a single stroke is added.

In the flowchart depicted in FIG. 10, firstly, the sample 401 of a handwritten character (question) to be written and the answer input frame 402 are displayed, based on the question content, on the display 225a (step S1001). Subsequently, guidance information (e.g. [symbol] in FIG. 4) is displayed at the first point of the stroke of the character within the answer input frame 402 displayed at step S1001 (step S1002).

Then, the input of the strokes (writing of the strokes) by the predetermined operation member 130 such as the digitizer is received and whether the input of the strokes is continuing is determined (step S1003). For example, whether the displayed guidance information portion is a normal pen pressure higher than the threshold is determined.

When a result of the determination at step S1003 is that the input of strokes is continuing (step S1003: YES), the process proceeds to step S1004. On the other hand, when the input of strokes is not continuing (step S1003: NO), the process proceeds to step S1005.

At step S1004, whether the input strokes hit the guidance information ( [symbol] ) is judged (step S1004). For example, whether the displayed portion of guidance information ( [symbol] ) has been traced is determined. When a result of the judgment at step S1004 is that the input strokes hit the guidance information (step S1004: YES), the process proceeds to step S1007, and when the input strokes do not hit the guidance information (step S1004: NO), the process returns to step S1003.

At step S1005, since the input of the strokes is not continuing, a message urging the user to rewrite the character is output (step S1005), the previously input stroke is erased (step S1006), and the process returns to step S1002.

At step S1007, the pen pressure of the stroke at the hit point is judged (step S1007). Then, the display shape of the current point is determined (step S1008). For example, when the pen pressure is higher than the threshold, the guidance information ( [symbol] ) is to be kept displayed, and when the pen pressure is lower than the threshold, the guidance information is to be displayed in a (o) shape indicating low pen pressure, and the strokes are displayed in the determined display shape (step S1009).

Whether the current checkpoint is the last checkpoint of the stroke is determined (step S1010). For example, when the character has multiple strokes, whether the last point of one stroke has been reached is determined. When the current checkpoint is the last checkpoint of the stroke (step S1010: YES), the process proceeds to step S1012. On the other hand, when the current checkpoint is not the last checkpoint of the stroke (step S1010: NO), the guidance information is moved to and displayed at the next point (step S1011), and the process returns to step S1003.

Whether the input of all strokes has been received is determined (step S1012). For example, when the character has multiple strokes, whether the strokes have been written up to the last point of the last stroke is determined. When the input of all strokes has not been received (step S1012: NO), the process returns to step S1002. On the other hand, when the input of all strokes has been received (step S1012: YES), a presentation corresponding to the display shapes of all the points is played (step S1013) and the above series of processes is terminated.

At step S1013, for example, when the display shape of all the points is [symbol] , a presentation is played tracing the entire character according to the stroke order and indicating that the pen pressure is normal and above the threshold (for example, see FIG. 8). On the other hand, when the display shape of some points is ∘, a presentation is played tracing the entire character according to the stroke order and indicating that at some points, the pen pressure is low. In this case, as the played presentation, for example, a message urging the user to rewrite the character is output via the display 225a or the speaker 227.

As described above, the learning support program, the learning support device, and the learning support method of the embodiments of the present invention receive the input of handwritten characters from a user who has been requested to write the characters, recognize the input handwritten characters or the strokes of the handwritten characters, and judge the stroke order of the recognized handwritten characters or the strokes of the handwritten characters and output information related to a result of the judging.

According to the present invention, the stroke order of the handwritten character or the strokes of the handwritten character can be conveyed to the user, thereby making the user aware of writing the character in the appropriate stroke order.

The learning support program, the learning support device, and the learning support method according to the embodiment of the present invention may include a process of displaying the guiding object that guides the user in the stroke order of handwritten characters when requesting the user to write. The guiding object may include, for example, the guidance information displayed superimposed on the handwritten characters to guide the user along a path to trace the characters from the starting position to the ending position. The guidance information may be, for example, information displayed superimposed on the handwritten characters to guide the user to trace the characters sequentially along multiple points from the starting position to the ending position, and the display of the guidance information for the next point may be repeated according to the state in which the user traces the characters at the position of the point guidance information. The guiding object may include the direction information displayed along a side part of the handwritten characters, indicating the direction of the stroke order of the characters.

According to the invention, the stroke order of the handwritten character or strokes of the handwritten character may be visually conveyed to the user in an easily understandable manner. This may more reliably make the user to pay attention to writing characters in the correct stroke order.

In the learning support program, the learning support device, and the learning support method of the embodiments of the present invention, the output process may output information concerning the result of judging by displaying the recognized handwritten character or the strokes of the handwritten character, and the stroke order of the handwritten character or strokes of the handwritten character.

According to the invention, the correct stroke order is displayed after the user writes the handwritten character, thereby more reliably and successfully making the user to pay attention to writing the characters in the correct stroke order.

In the learning support program, the learning support device, and the learning support method of the embodiments of the invention, the output process may output information concerning the result of the judging, by displaying the recognized handwritten character or the strokes of the handwritten character, and information corresponding to the handwritten character or the pen pressure of strokes of the handwritten character.

According to the invention, the pen pressure of the handwritten character or strokes of the handwritten character may be visually conveyed to the user in an easily understandable manner, thereby more reliably and successfully making the user pay attention to writing the characters with the appropriate pen pressure.

In the learning support program, the learning support device, and the learning support method of the embodiments of the present invention, the output process may include playing a presentation in which the recognized handwritten character or strokes of the handwritten character correspond to the results of judging the stroke order and pen pressure of the handwritten character or strokes of the handwritten character.

According to the invention, by playing the presentation corresponding to the result of judging the stroke order and pen pressure of the handwritten character or the stroke of the handwritten character, the information can be visually conveyed to the user in an easily understandable manner. This can, more reliably, make the user to pay attention to writing the characters in the appropriate stroke order and with the appropriate pen pressure.

In the learning support program, the learning support device, and the learning support method of the embodiments of the present invention, the judging process may include comparing the pen pressure of the recognized handwritten character or strokes of the handwritten character with predetermined pen pressures at multiple points and the output process may include displaying the points where the pen pressure is low.

According to the invention, by indicating, to the user, the points where the pen pressure is low in the handwritten character or in the strokes of the handwritten character, the user can be visually informed in an easily understandable manner. Therefore, more reliably, the user is made to pay attention to writing the characters with the appropriate pen pressure.

In the learning support program, the learning support device, and the learning support method of the embodiments of the present invention, the judging process may compare the pen pressure of the recognized handwritten character or of a stroke of the handwritten character with a predetermined threshold set for the handwritten character or the stroke to judge the pen pressure, and the output process may be such that, when the pen pressure of the recognized handwritten character or of the stroke of the handwritten character is lower than the threshold, the display of the handwritten character or stroke previously input is erased and information is output requesting the rewriting of the handwritten character or stroke previously input.

According to the invention, in a case that the pen pressure of the recognized handwritten character or of a stroke of the handwritten character is lower than the threshold for judging, a request for the rewriting of the handwritten character or stroke informs the user that the pen pressure is low and urges the user to repeat learning so as to obtain the correct pen pressure.

In the learning assistance program, the learning assistance device, and the learning assistance method according to the embodiments of the present invention, the output process may output information concerning the judgment result by outputting a voice giving notification of the judgment result.

According to the invention, by giving notification of the judgment result by voice, the sense of hearing, in addition to the sense of touch for handwriting, can be stimulated. For young users such as toddlers and elementary school children, conveying audio messages corresponding to the judgment results of the stroke order and pen pressure is effective to instill awareness of the need to increase the pen pressure. This is effective, in particular, for young users in instilling awareness of the need to increase their pen pressure.

What is known is that there is a deep correlation between the strength of the fingers and the development of the frontal lobe of the brain, and that adequate stimulation can activate the brain. The development of the ability to make comprehensive judgments about things is known to be promoted by improving the strength of the fingers. According to the invention, by urging children to write the handwritten characters with the appropriate stroke order and pen pressure, in addition to acquiring the ability to write characters by hand, activation of the brain and the improvement of ability to make comprehensive judgments about things are expected.

The learning support method described in the present embodiment may be implemented by executing a prepared program on a computer such as a personal computer and a workstation. The program is stored on a computer-readable recording medium such as a hard disk, a flexible disk, a CD-ROM, an MO, and a DVD; and the program is read out from the computer-readable medium and executed by the computer. The program may be distributed through a network such as the Internet.

According to the learning support program, the learning support device, and the learning support method of the present invention, the user can be made to be conscious of writing characters in the correct stroke order.

As described above, the learning support program, the learning support device, and the learning support method according to the present invention are useful as a learning support program, a learning support device, and a learning support method for supporting learning, and are particularly suitable for a learning support program, a learning support method, and a learning support device supporting learning by inputting answers as handwritten characters.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium storing therein a learning support program causing a computer to execute a process comprising:
receiving input of a character that a user is requested to write, the character being handwritten and input by the user;
recognizing the input character or strokes of the input character;
judging the recognized character or a stroke order of the strokes of the recognized character; and
outputting information concerning a result of the judging.

2. The recording medium according to claim 1, the process further comprising:
displaying a guiding object that provides guidance regarding the stroke order of the character when the user is requested to write the character.

3. The recording medium according to claim 2, wherein the guiding object includes guidance information displayed superimposed on the character, the guidance information providing guidance regarding a position for tracing the character between a writing start position and a writing end position.

4. The recording medium according to claim 3, wherein
the guidance information provides guidance for sequentially tracing through a plurality of points to trace the character between the writing start position and the writing end position, and
the displaying includes, for each of the plurality of points, displaying a next point of the plurality of points depending on a state of the tracing of the character, by the user, at the position of the guidance information for the each of the plurality of points, the next point being subsequent to the each of the plurality of points.

5. The recording medium according to claim 2, wherein the guiding object includes direction information displayed on a side portion of the character, the direction information indicating a direction of the stroke order of the character.

6. The recording medium according to claim 1, wherein the outputting includes outputting the information concerning the result of the judging by displaying the recognized character or the strokes of the recognized character and the character or the stroke order of the strokes of the character.

7. The recording medium according to claim 1, wherein the outputting includes outputting the information concerning the result of the judging by displaying information in which the recognized character or the strokes of the recognized character are correlated with a handwriting pressure of the recognized character or handwriting pressures of the strokes of the recognized character.

8. The recording medium according to claim 1, wherein the outputting includes playing a presentation in which the recognized character or strokes of the recognized character are correlated with the result of judging the stroke order and handwriting pressures of the strokes of the recognized character.

9. The recording medium according to claim 1, wherein,
the judging includes judging the recognized character or the strokes of the recognized character by comparing handwriting pressures of the strokes of the recognized character to predetermined handwriting pressures at a plurality of points, and
the outputting includes outputting a display indicating a point where a handwriting pressure of the handwriting pressures of the strokes of the recognized character is low.

10. The recording medium according to claim 9, wherein
the judging includes judging the handwriting pressures with respect to the recognized character or the strokes of the recognized character by comparing the handwriting pressures of the strokes of the recognized character with predetermined threshold values set for the character or strokes of the character, and
the outputting includes erasing display of a most-recently input character or stroke and outputting information requesting rewriting of the most-recently input character or stroke, when the handwriting pressures of the strokes of the recognized character are lower than the predetermined threshold values.

11. The recording medium according to claim 1, wherein
the outputting includes outputting a voice notifying the user of the result of the judging.

12. A learning support device, comprising a control unit configured to:
receiving input of a character that a user is requested to write, the character being handwritten and input by the user;
recognizing the input character or strokes of the input character;
judging the recognized character or a stroke order of the strokes of the recognized character; and
outputting information concerning a result of the judging.

13. A learning support method executed by a computer, the learning support method comprising:
receiving input of a character that a user is requested to write, the character being handwritten and input by the user;
recognizing the input character or strokes of the input character;
judging the recognized character or a stroke order of the strokes of the recognized character; and
outputting information concerning a result of the judging.
